(19) United States
(12) Patent Application Publication
(10) Pub. No.: US 2016/0328487 A1
(43) Pub. Date: Nov. 10, 2016

(54) APPARATUS AND METHOD CAPABLE OF DISPLAYING COPYRIGHT INFORMATION IN ELECTRONIC PUBLICATION

(71) Applicant: FASOO.COM CO., LTD., Seoul (KR)

(72) Inventors: Hun-Jun KIM, Seoul (KR); Yeong-Hun YI, Seoul (KR)

(21) Appl. No.: 15/109,195

(22) PCT Filed: Jan. 23, 2014
(86) PCT No.: PCT/KR2014/000672

§ 371 Date: Jun. 30, 2016

(30) Foreign Application Priority Data
Dec. 30, 2013 (KR) 10-2013-0166749

(51) Int. Cl. G06F 17/30; G06F 21/10

(52) U.S. Cl. CPC G06F 17/30941; G06F 17/30929; G06F 21/10

(57) ABSTRACT

Disclosed are an apparatus and a method capable of displaying copyright information in an EPUB. A file access unit outputs a schema of a copyrighted EPUB material corresponding to the definition of an EPUB. A copyright information compilation unit receives, from a user, a user-inputted value of items constituting the copyright information from among items constituting a party of an XML, file in which authorization information is recorded, from among XML files included in the schema of the copyrighted EPUB material, and then records the value in the XML file in which the authorization information has been recorded. According to the present disclosure, by defining a field for displaying copyright information in Rights.xlm in the details of an EPUB, copyright information can be inputted into an e-book by using an EPUB copyrighting tool, and the copyright information can be read by means of an EPUB viewer.

### TECHNICAL FIELD

The present disclosure relates to an apparatus and a method capable of displaying copyright information in an Electronic Publication (EPUB) file, and more particularly to an apparatus and a method for displaying copyright information in an EPUB file according to a de facto-standard established by an international digital publishing forum (IDPF).

### BACKGROUND ART

The Electronic Publication (EPUB) file is an electronic book format according to a de facto standard established by the international digital publishing forum (IDPF). In connected with the EPUB file format, an EPUB version 3.0 was released in Oct. 11, 2011. However, even when the EPUB file format is used, various digital rights management (DRM) methods for content protection may be used according to various software producers, distributors, and service providers. That is, the EPUB does not specify its DRM method. The DRM is used for encryption for content protection, right management for contents use, or management for electronic signatures for forgery prevention. Only users, permitted through such the application of DRM, can read an EPUB electronic book. Also, reading, reproduction, printing, etc. of the EPUB file can be restricted by the DRM. Also, the use period of the EPUB electronic book may be restricted by the DRM.

On the other hand, although the EPUB file format provides specification on encryption and electronic signature for content protection, it does not provide specification on rights. Since information on authors, copyright holders, etc. is essential, a method for displaying information on the copyright holder, according to specification of the EPUB, is strongly demanded.

Also, the Korean patent publication No. 2004-0101311 (published on Dec. 2, 2004) disclosed an apparatus and a method in which a right expression is designated in an original format of a content, an intermediate expression for representing rights based on at least one of syntax information and semantics information related to the original format is generated, the right expression designates usage manner of the content for implementation in the apparatus, and the right expression related to the content encrypted by using a syntax based language is processed. However, such the prior art defines only rights for content use. That is, the prior art did not disclose or teach techniques for defining or processing detail specification on rights.

### DISCLOSURE

### Technical Problem

The purpose of the present disclosure for resolving the above-described problem is to provide an apparatus and a method, according to the EPUB specification, for displaying copyright information for an EPUB electronic book or respective contents such as text, image, video, etc. included in the EPUB electronic book.

Also, another purpose of the present disclosure for resolving the above-described problem is to provide a computer-readable recording medium storing a computer program for executing the method for displaying copyright information for an EPUB electronic book or respective contents such as text, image, video, etc. included in the EPUB electronic book.

### Technical Solution

In order to achieve the above-described purpose of the present disclosure, an apparatus for displaying copyright information in an Electronic Publication (EPUB) file, according to the present disclosure, may comprise a file access unit configured to output a schema of a copyrighted EPUB material corresponding to a definition of EPUB; and a copyright information compilation unit configure to receive, from a user, user-inputted values of items constituting the copyright information from among items constituting a party element of an extensible markup language (XML) file in which right information is recorded, from among XML files included in the schema of the copyrighted EPUB material, and record the user-inputted values in the XML file in which the right information is recorded.

In order to achieve the above-described purpose of the present disclosure, a method for displaying copyright information in an Electronic Publication (EPUB) file, according to the present disclosure, may comprise (a) outputting a schema of a copyrighted EPUB material corresponding to a definition of EPUB; and (b) receiving, from a user, user-inputted values of items constituting the copyright information from among items constituting a party element of an extensible markup language (XML) file in which right information is recorded, from among XML files included in the schema of the copyrighted EPUB material, and recording the user-inputted values in the XML file in which the right information is recorded.

### Advantageous Effects

Using the apparatus and method for displaying copyright information in the EPUB file according to the present disclosure, fields for representing copyright information are defined in rights.xml according to the EPUB specification, and thus copyright information can be inputted to an electronic book by using an EPUB authoring tool, and the copyright information can be browsed by using an EPUB viewer. Also, it can become possible to display copyright information for an EPUB electronic book or respective contents such as text, image, video, etc. included in the EPUB electronic book.

### DESCRIPTION OF DRAWINGS

FIG. 1 is a view illustrating a configuration of a preferred exemplary embodiment of an apparatus capable of displaying copyright information in an EPUB file according to the present disclosure;

FIG. 2 is a view illustrating a hierarchical schema of an EPUB material;

FIG. 3 is a view illustrating profiles of rights, agreement, and party constituting right.xml;

FIG. 4 is a view illustrating a schema of the party; and

FIG. 5 is a flow chart illustrating a method for displaying copyright information in an EPUB file according to a preferred exemplary embodiment of the present disclosure.

### BEST MODE

Hereinafter, preferred exemplary embodiments of an apparatus and a method for displaying copyright information in an EPUB file, according to the present disclosure, will be explained in detail by referring to accompanying figures.

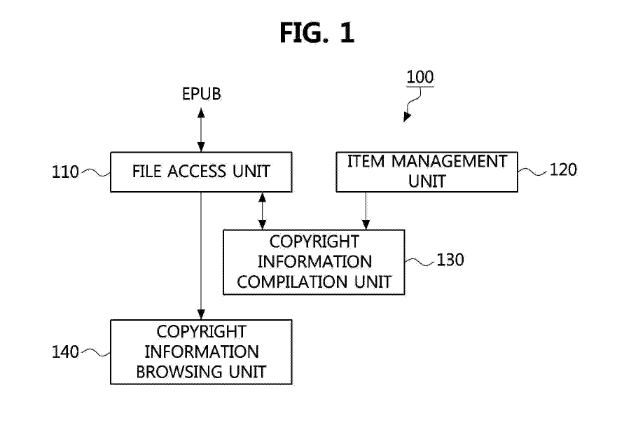

FIG. 1 is a view illustrating a configuration of a preferred exemplary embodiment of an apparatus capable of displaying copyright information in an EPUB file according to the present disclosure.

Referring to FIG. 1, the preferred exemplary embodiment of the apparatus 100 for displaying copyright information in an EPUB file, according to the present disclosure, may comprise a file access unit 110, an item management part 120, a copyright information compilation unit 130, and a copyright information browsing unit 140.

The file access unit 110 may be configured to read out a copyrighted electronic book (hereinafter, referred to as ‘EPUB material’) according to the EPUB specification from a storage means (not depicted), and then output a schema of the EPUB material. For this, the file access unit 110 may have a function of extracting the schema from an extensible markup language (XML) document. Meanwhile, the storage means may be included in the apparatus 100 for displaying copyright information in the EPUB file according to the present disclosure. Also, a work server providing EPUB materials through a communication network may operate as the storage means. In this case, the file access unit 110 may have a communication means for receiving the EPUB material by accessing the work server.

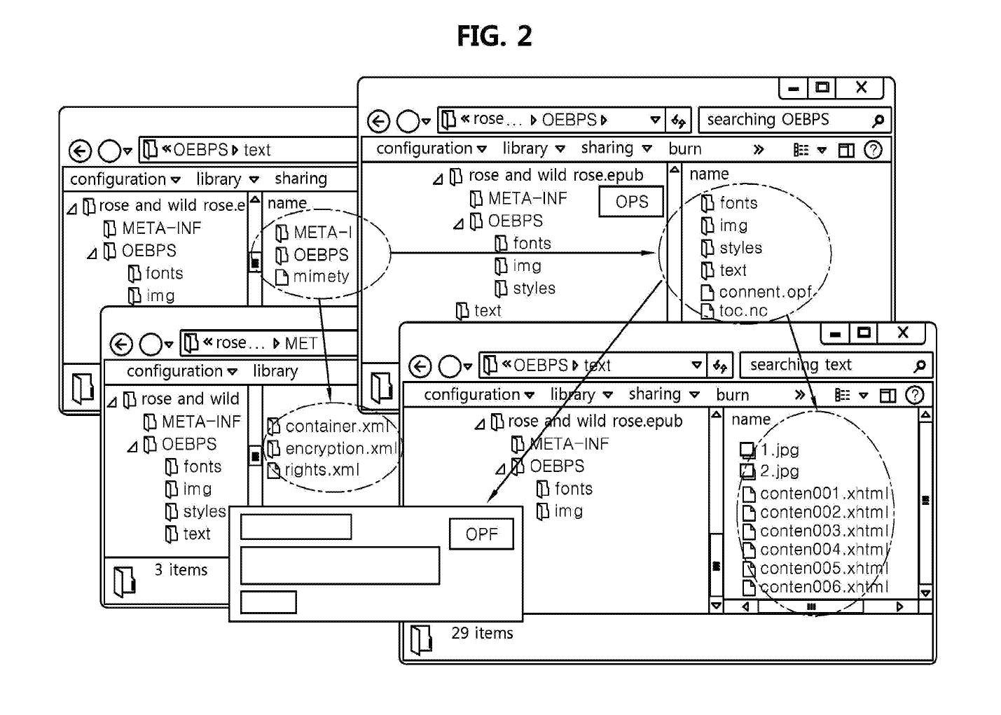

FIG. 2 is a view illustrating a hierarchical schema of an EPUB material.

Referring to FIG. 2, the EPUB material may comprise META-INF, Open eBook Publication Structure (OEBPS) folder, and Open Container Format (OCF) including mimetype. Also, the META-INF may comprise encryption.xml, signatures.xml, and rights.xml. The followings are examples of encryption.xml, signatures.xml, and rights.xml.

### [Encryption.Xml]

<?xml version=“1.0” encoding=“UTF-8”?>
<xenc:EncryptedData xmlns:enc=“http://www.w3.org/2001/04/xmlenc#”>

<xenc:EncryptionMethod Algorithm=“http://www.w3.org/2001/04/xmlenc#aes128-

cbc”/>

<ds:KeyInfo xmlns:ds=“http://www.w3.org/2000/09/xmldsig#”>

<ds:RetrievalMethod URI=“#EK” Type=“http://www.w3.org/2001/04/xmlenc#

EncyrptedKey”/>

</ds:KeyInfo>
<xenc:CipherData>

<xenc:CiphierReference URI=“OEBPS/content.html”/>

</xenc:CipherData>

</xenc:EncryptedData>
<xenc:EncryptedKey xmlns:enc=“http://www.w3.org/2001/04/xmlenc#” Id=“EK”>

<xenc:EncryptionMethod Algorithm=“http://www.w3.org/2001/04/xmlenc#rsa-oaep-

mgflp”/>

<ds:KeyInfo xmlns:ds=“http://www.w3.org/2000/09/xmldsig#”>

<ds:KeyName>dnQualifier=duyeE2kTAtuwcuMr2peYsQKu54k=,CN=Custome

r Name, O=SP Name,C=kr</ds:KeyName>

</ds:KeyInfo>

<xenc:CipherData>

<xenc:CipherValue>YkOPSj+mvrQvTgQTQ8RPiejcCULqQM0E8Etbd5fDhXYD

6QmTCeAcSt+Cvte+V3Luzs281CG1py9ES5JEZ412QY7YdNt41KtnzVbmG2elETO7
KR2vH9tM2w1PaGWnsKgakA32YL/SaDWTn6dcerF9RuVa0kNkk/MOdyRz+6K/69
M=</xenc:CipherValue>

</xenc:CipherData>

</xenc:EncryptedKey>
</encryption>

### [Signatures.Xml]

<?xml version=“1.0” encoding=“utf-8”?>
<signatures xmlns=“urn:oasis:names:tc:oepndocument:xmlns:container”>
<ds:Signature xmlns:ds=“http://www.w3.org/2001/04/xmldsig#” id=“sig”>
<ds:SignedInfo>
<ds:CanonicalizationMethod Algorithm=“http://www.w3.org/TR/2001/ REC-xml-c14n-
20010315”/>
<ds:SignatureMethod Algorithm=“http://www.w3.org/2001/04/xmldsig- more#rsa-
sha256”/>
<ds:Reference URI=“#Manifest1”>

<ds:Transforms>

| | |
|---|---|
| <ds:Transform | Algorithm=“http://www.w3.org/TR/2001/REC-xml-c14n- |

20010315”/>

</ds:Transforms>
<ds:DigestMethod Algorithm=“http://www.w3.org/2001/04/xmlenc# sha256”/>
<ds:DigestValue>bwgDJdYcRZEqpURBVgx/UZL8h4nzAgFPK715ey1jooU=</ds:

DigestValue>
</ds:Reference>
<ds:Transforms>

| | |
|---|---|
| <ds:Transform | Algorithm=“http://www.w3.org/TR/2001/REC-xml-c14n- |

20010315”/>
</ds:Transforms>
<ds:DigestMethod Algorithm=“http://www.w3.org/2001/04/xmlenc#sha256”/>
<ds:DigestValue>3VOuQz+ikh8LpdZCXsfmKJUofMQ0dDRoToiJ6sB7ZKY=</ds:
DigestValue>
</ds:Reference>
</ds:SignedInfo>
<ds:SignatureValue>XR4iR9Z1r+MOZT4eyirceWzJ2qrphjpnvj3zMDb1oPpVnqxI/1Hx
JfF1YjeV5534W+mmazeHStOFLjqTW/1kGY8bJ7cb8y65XcsZknZJURqIoRhjD6kHYi
4Yt6gPR/JyIdxFVNqDAGjqcRDp38gojR7bttn/e+6qKqyOOMP84//+on9NyAgkdMhT
VObHgnC1qwVeD93HxSw0ptLMMz59j/7qpr2NIu5z7AadKFgrOz+tD4QUP4EvWB3
YM6zJ11R7udVfd/mxtSwcxg4g69iBnKAn1zRR681HB07hGrxuFizLAr7pfH/u3Reftoe
e3TcRHYk+RMA72BJG8sUnmVUcWQ==</ds:SignatureValue>
:

### [Rights.Xml]

<?xml version=“1.0” encoding=“UTF-8”?>
<o-ex:rights xmlns=“http://odrl.net/1.1/ODRL-EX”
xmlns:o-ex=“http://odrl.net/1.1/ODRL-EX”
xmlns:o-dd=“http://odrl.net/1.1/ODRL-DD”
xmlns:ebr=“http://e-book.copyrights.or.kr/1.0/rel/EBR-DD”
xmlns:xsi=“http://www.w3.org/2001/XMLSchema-instance”
xsi:schemaLocation=“http://e-book.copyrights.or.kr/1.0/rel/EBR-DD
EBR-DD- 10.xsd”>
<o-ex:context>
<o-dd:uid>RightsObjectID</o-dd:uid>
</o-ex:context>

<o-ex:agreement>
<o-ex:asset>

:

</o-ex:asset>
<o-ex:permission>

<o-dd:display/>
<o-dd:print/>

</o-ex:permission>
<o-ex:constraint>
<o-dd:group>

<o-ex:context>

<o-dd:uid>membership A</o-dd:uid>

</o-ex:context>

</o-dd:group>

:

Also, Open Publication Structure (OPS) may comprise fonts, images, styles, text folders, content.opf, and toc.ncx. Also, the context.opf, as an Open Packaging File (OPF) file, includes metadata of the EPUB material. Here, OCF, OPS, and OPF are specifications defined in EPUB of IDPF. The OCF is a compressed file including all files, the OPS includes a format of content, and the OPF represents a structure of the EPUB file composed in XML. The below table 1 provides descriptions on META-INF files of the OCF.

TABLE 1

| OCF Item | Description |
|---|---|
| META-INF/ | referred W3C XML encryption standard |
| encryption.xml | explanation on encryption target, algorithm, and key |
| | information |
| META-INF/ | referred W3C XML signature standard |
| signature.xml | explanation on signature target, algorithm, and |
| | verification certificate |
| META-INF/rights. | specification is not defined |
| xml | arbitrary right expression language may be used |

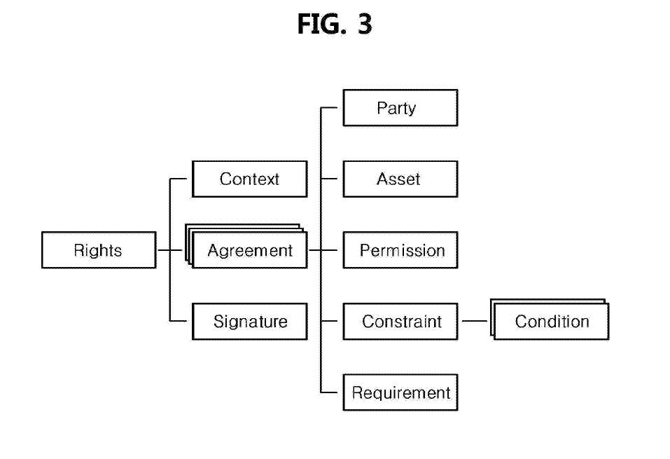

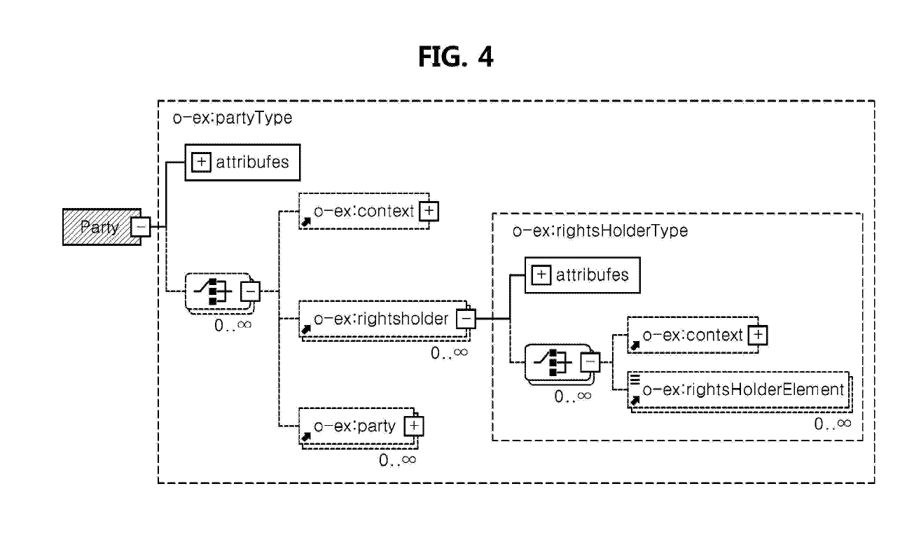

The item management unit 120 may manage respective items of copyright information to be defined within an ‘Party’ element among elements ‘Rights’, ‘Agreement’, and ‘Party’ constituting right.xml. FIG. 3 illustrates profiles of ‘Rights’, ‘Agreement’, and ‘Party’ constituting right.xml. Referring to FIG. 3, an EPUB material profile in rights.xml may comprise a ‘Context’ representing identification information (ID) used when the ‘Rights’ is referred externally, an ‘Agreement’ which is related to agreement on copyright information and rights, and a ‘Signature’ for guaranteeing integrity of right expression information. Also, the ‘Agreement’ may comprise a ‘Party’ including information on a copyright of content and a copyright holder, an ‘Asset’ designating contents under the copyright and rights, a ‘Permissions’ which is information on the rights, and a ‘Constraint’ representing conditions for executing the rights. Such the ‘Agreement’ may include information on the copyright holder of the content (type of copyright, copyright holder, e-mail address, address, etc.), and detail information required for the rights holder (content owner, service operator, etc.) to approve a user of using the content. For example, the detail information may include a content identifier, content using method, content using condition, etc. The ‘Agreement’ may be generated for each asset indicating an EPUB material or content (text, image, video, etc.) included in the EPUB material under respective copyrights and rights. Also, the ‘Party’, as an information element for displaying copyright information (copyright type, copyright holder, e-mail address, address, postal code, city, country, telephone number, facsimile number, etc.) of the EPUB material, is used for displaying copyright information for each EPUB material or each content included in the EPUB material (specified by ‘asset’). FIG. 4 illustrates schema of the ‘Party’. Also, the below table 2 describes attributes and contents of respective items constituting the ‘Party’ element.

TABLE 2

| Item/Attribute | Appearance | Mandatory | Remarks |
|---|---|---|---|
| o-ex;party | 0,,1 | ∘ | — |
| @o-ex;id | 0,,1 | ∘ | Identifier for internal reuse |
| @o-ex;idref | 0,,1 | ∘ | Reusing already-declared |
| | | | internal identifier |
| @##other | 0,,1 | ∘ | Attribute for extension |
| 0-ex;context | 0,,1 | ∘ | Content identifier |
| o-ex;rightholder | 0,,n | ∘ | Information on copyright and |
| | | | copyright holder |
| o-ebr;e-mail | 0,,1 | x | Copyright holder e-mail |
| | | | address |
| o-ebr;address | 0,,1 | x | Copyright holder address |
| o-ebr;zip-code | 0,,1 | x | Copyright holder postal code |
| o-ebr;city | 0,,1 | x | Copyright holder city |
| o-ebr;state | 0,,1 | x | Copyright holder state |
| o-ebr;country | 0,,1 | x | Copyright holder country |
| o-ebr;phone | 0,,1 | x | Copyright holder telephone |
| | | | number |
| o-ebr;fax | 0,,1 | x | Copyright holder facsimile |
| o-ebr;party | 0,,1 | ∘ | Previous copyright |
| | | | information |

Also, the ‘Assets’, as an element for representing identification information of an EPUB material, may be used for specifying content whose permission is required to be assigned among the EPUB material or each content included in the EPUB material. Also, the ‘Permissions’ may be used for specifying at least one use type (e.g. reading, printing, storing an original copy, transfer, etc.) of the EPUB material. Also, the ‘Constraint’ may be used for specifying use conditions required for the EPUB material to be used, and the use conditions may include designation of users or groups, use time, number of use, used device, used software, etc. Also, the ‘Requirements’ may be used for specifying requirements for use of the EPUB material, and may include agreement on a CCL license, etc. Also, the ‘Signature’ may be used for proving, by a reliable issuer, that “EPUB DRM REL’ is not changed through an electronic signature manner.

The item management unit 120 may add or remove an item selected by an operator among the items (copyright holder e-mail address, copyright holder address, copyright holder postal code, copyright holder city, copyright holder state, copyright holder country, copyright holder telephone number, copyright holder facsimile number, etc.) of the table 2 constituting the copyright information. The item management unit 120 may be an optional component. If the item management unit 120 does not exist, respective items constituting the copyright information may be pre-configured by the copyright information compilation unit 130.

The copyright information compilation unit 130 may output, to the user, items of the ‘Party’ in right.xml constituting the schema of the EPUB material, which the file access unit 110 read out, receive values of the respective items from the user, and record the values in right.xml. Here, the copyright information compilation unit 130 may obtain respective items and attributes of the ‘Party’ element from the item management part 120, or use preconfigured respective items and attributes. The below examples illustrate an example of ‘Party’ items generated by the copyright information compilation unit 130 and an example of copyright information.

### [Example of Party Item]

<xsd:element name=“party” type=“o-ex:partyType”/>
<xsd:complexType name=“partyType”>

<xsd:sequence minOccurs=“0” maxOccurs=“unbounded”>

<xsd:element ref=“o-ex:context” minOccurs=“0”/>
<xsd:element ref=“o-ex:rightsholder”
minOccurs=“0”maxOccurs= “unbounded”/>
<xsd:element ref=“o-ex:party” minOccurs=“0”/>

</xsd:sequence>
<xsd:attributeGroup ref=“o-ex:IDGroup”/>

</xsd:complexType>

### [Example of Copyright Information]

<xsd:element name=“rightsHolder” type=“o-ex:rightsHolderType”/>
<xsd:complexType name=“rightsHolderType”>

<xsd:choice minOccurs=“0” maxOccurs=“unbounded”>

<xsd:element ref=“o-ex:context” minOccurs=“0”/>
<xsd:element ref=“o-ex:rightsHolderElement” minOccurs=“0” maxOccurs=

“unbounded”/>

</xsd:choice>
<xsd:attributeGroup ref=“o-ex:IDGroup”/>

</xsd:complexType>
<!-- Declare basic Party Elements (o-dd namespace) -->
<xsd:element name=“e-mail” type=“o-ex:rightsHoderType” substitutionGroup= “o-
ex:rightsHolderElement”/>
<xsd:element name=“address” type=“o-ex:rightsHoderType” substitutionGroup= “o-
ex:rightsHolderElement”/>
<xsd:element name=“zip-code” type=“o-ex:rightsHoderType” substitutionGroup= “o-
ex:rightsHolderElement”/>
<xsd:element name=“city” type=“o-ex:rightsHoderType” substitutionGroup=“o-ex:
rightsHolderElement”/>
<xsd:element name=“state” type=“o-ex:rightsHoderType” substitutionGroup= “o-
ex:rightsHolderElement”/>
<xsd:element name=“ country” type=“o-ex:rightsHoderType” substitutionGroup= “o-
ex:rightsHolderElement”/>
<xsd:element name=“phone” type=“o-ex:rightsHoderType” substitutionGroup= “o-
ex:rightsHolderElement”/>
<xsd:element name=“fax” type=“o-ex:rightsHoderType” substitutionGroup= “o-
ex:rightsHolderElement”/>

The copyright information browsing unit 140 may be configured to output copyright information recorder for items of the party of right.xml constituting the schema of the copyrighted EPUB material which the file access unit 110 read out. Here, the copyright information browsing unit may be configured to output the copyright information for the content included in the EPUB material by using a pop-up window when a cursor is located on the content for which the copyright information is configured. The copyrighting information browsing unit 140 may be added to an EPUB viewer as an independent module. In this case, the conventional EPUB viewer may perform the function of the file access unit 110.

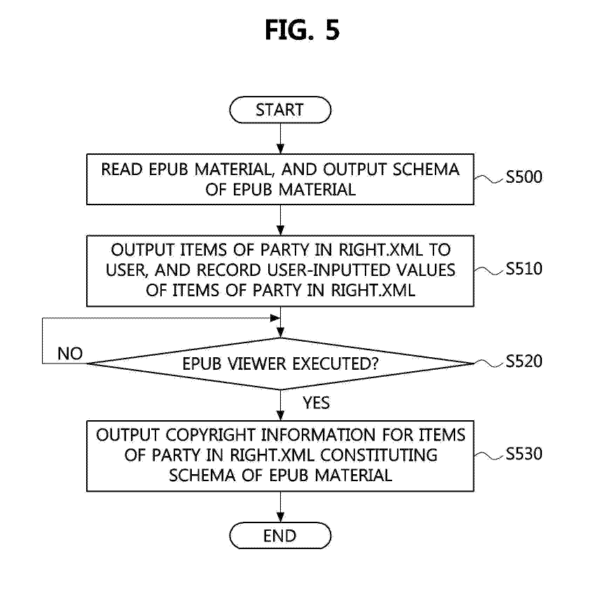

FIG. 5 is a flow chart illustrating a method for displaying copyright information in an EPUB file according to a preferred exemplary embodiment of the present disclosure.

Referring to FIG. 5, the file access unit 110 may read out a copyrighted EPUB material from a storage means (not depicted), and then output a schema of the copyrighted EPUB material (S500). The copyright information compilation unit 130 may output, to a user, respective items of a party of a right.xml constituting the schema of the copyrighted EPUB material which the file access unit 110 read out, and record user-inputted values of the items of the party in right.xml (S510). If an EPUB viewer is driven (S520) after the copyright information was generated as described above, the copyright information browsing unit 140 may output, to the user, the copyright information recorded for the items of the party of right.xml constituting the schema of the copyrighted EPUB material (S530).

The apparatuses and methods according to the present disclosure may be implemented as a program code recorded in a computer-readable recording medium. The computer-readable recording medium may include all types of storage devices on which computer-readable data can be stored. For example, the computer-readable recording medium may be read-only memory (ROM), random access memory (RAM), compact disc ROM (CD-ROM), magnetic tape, a floppy disc, an optical data storage device, etc. Also, a carrier wave (i.e., transmission through internet) may be included as the computer-readable recording medium. Also, the computer-readable recording medium may be distributed over computer systems connected through wire or wireless communication networks, and the computer-readable program code can be stored and executed in the distributive manner.

While the example embodiments of the present disclosure and their advantages have been described in detail, it should be understood that various changes, substitutions and alterations may be made herein without departing from the scope of the disclosure.

1. An apparatus for displaying copyright information in an Electronic Publication (EPUB) file, the apparatus comprising:
a file access unit configured to output a schema of a copyrighted EPUB material corresponding to a definition of EPUB; and
a copyright information compilation unit configure to receive, from a user, user-inputted values of items constituting the copyright information from among items constituting a party element of an extensible markup language (XML) file in which right information is recorded, from among XML files included in the schema of the copyrighted EPUB material, and record the user-inputted values in the XML file in which the right information is recorded.

2. The apparatus according to claim 1, further comprising a copyright information browsing unit configured to read values of items constituting the party element of the XML file in which right information is recorded, and output copyright information for content included in the copyrighted EPUB material to the user.

3. The apparatus according to claim 2, wherein the copyright information browsing unit outputs the copyright information for the content included in the copyrighted EPUB material by using a pop-up window when a cursor is located on the content for which the copyright information is configured.

4. The apparatus according to claim 1, further comprising an item management unit configured to add or remove an item selected by the user to or from the items constituting the copyright information.

5. A method for displaying copyright information in an Electronic Publication (EPUB) file, the method comprising:
(a) outputting a schema of a copyrighted EPUB material corresponding to a definition of EPUB; and
(b) receiving, from a user, user-inputted values of items constituting the copyright information from among items constituting a party element of an extensible markup language (XML) file in which right information is recorded, from among XML files included in the schema of the copyrighted EPUB material, and recording the user-inputted values in the XML file in which the right information is recorded.

6. The method according to claim 5, further comprising (c) reading values of items constituting the party element of the XML file in which right information is recorded, and outputting copyright information for content included in the copyrighted EPUB material to the user.

7. The method according to claim 6, wherein, in the step (c), the copyright information for the content included in the copyrighted EPUB material is displayed by using a pop-up window when a cursor is located on the content for which the copyright information is configured.

8. The method according to claim 5, further comprising (d) adding or removing an item selected by the user to or from the items constituting the copyright information.

9. A computer-readable recording medium in which a program for executing the method according to claim 5 is recorded.

10. The apparatus according to claim 2, further comprising an item management unit configured to add or remove an item selected by the user to or from the items constituting the copyright information.

11. A computer-readable recording medium in which a program for executing the method according to claim 6 is recorded.

12. A computer-readable recording medium in which a program for executing the method according to claim 7 is recorded.
